(19) United States
(12) Patent Application Publication
(10) Pub. No.: US 2024/0254767 A1
(43) Pub. Date: Aug. 1, 2024

(54) DEVICE FOR COVERING PENETRATIONS AND VOIDS

(71) Applicants: Gregory Wilson Sharp, La Porte, TX (US); James Courtney Sandel, Deer Park, TX (US)

(72) Inventors: Gregory Wilson Sharp, La Porte, TX (US); James Courtney Sandel, Deer Park, TX (US)

(21) Appl. No.: 18/426,819

(22) Filed: Jan. 30, 2024

Related U.S. Application Data
(60) Provisional application No. 63/441,944, filed on Jan. 30, 2023.

(51) Int. Cl. E04B 5/48; F16L 5/02

(52) U.S. Cl. CPC E04B 5/48; F16L 5/02

(57) ABSTRACT

A device and method for covering a floor penetration around a pipework so as to prevent debris from falling into the floor penetration. The device includes a mesh portion. The device further includes an upper strap coupled to the upper edge portion of the mesh and extends further from the right edge of the mesh portion. The device further includes a lower strap coupled to the lower edge portion and extends further from the right edge. The device can be wrapped around the pipe so that the lower edge of the mesh portion is in contact with the floor, covering the floor penetration. The wrapped device can then be secured using the upper strap and the lower strap.

### CROSS-REFERENCE TO RELATED APPLICATIONS

This application claims priority from a U.S. Provisional Patent Appl. Ser. No. 63/441,944, filed on Jan. 30, 2023, which is incorporated herein by reference in its entirety.

### FIELD OF INVENTION

The present invention relates to a device for covering penetrations and voids in floors, and more particularly, the present invention relates to a device for covering the penetrations and voids in workspaces.

### BACKGROUND

Voids and gaps are common in workspaces, such as industries, production plants, and oil rigs. Floor voids and gaps around pipework are also common due to a variety of reasons.

Floor penetration is a requirement according to laws and fire codes. Floor penetration around pipe works is required according to the laws and fire code.

Retrieving small articles that accidentally fell into these voids, gaps, and penetrations can be quite difficult. Particularly, the penetrations around pipe works are hard to reach for retrieving any small article.

Thus, a need is there for covering such floor voids and penetrations around the pipe works without affecting any functionality of the penetrations.

The terms gaps, voids, and penetrations are interchangeably used hereinafter and refer to gaps around floor pipework.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a device that can be wrapped around a pipe for covering floor penetration.

It is another object of the present invention that the device is easy and quick to install.

Still another object of the present invention is that the device can be economical to manufacture.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows the device mounted to a pipe portion above the floor, according to an exemplary embodiment of the present invention.

FIG. 2 shows the device, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a device for covering floor penetrations. The disclosed device can cover a floor penetration preventing any small article from entering the floor penetration. For example, any small article accidentally falling over the floor penetration can be prevented from entering the penetration by the disclosed device. The disclosed device can be particularly useful in oil rigs for covering floor penetrations. The disclosed device in oil rigs can be wrapped around a portion of pipe just above the floor.

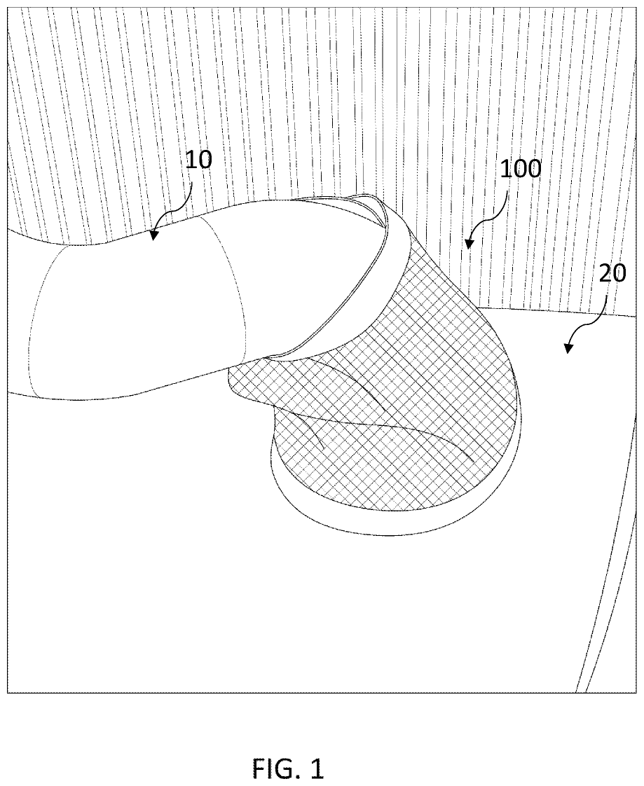

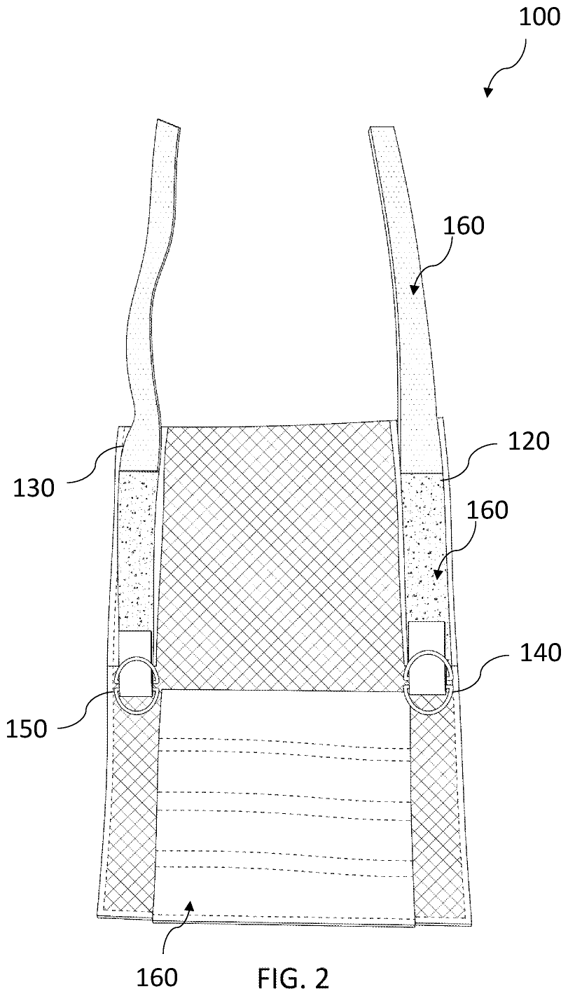

Referring to FIG. 1 illustrates the device is in working condition and FIG. 2 illustrates the device is unwrapped plain state. The device 100 has a central mesh portion 110 which is substantially rectangular. The size of the pores of the mesh can be varied without departing from the scope of the present invention. The size of the pores can be at least smaller than the size of common small articles being used at the site. The mesh may also prevent the entry of debris into the floor penetrations.

The mesh can be made from flame-retardant material, however, any suitable mesh material is within the scope of the present invention. The mesh can also have a coating of reflective material that enhances the visibility of the device, particularly, in low-light conditions. The mesh can be rectangular, however, any other shape is within the scope of the present invention, for example, the mesh can be a square shape. A border/hem can be applied to the periphery of the mesh for durability. The border/hem may also provide an aesthetic appearance to the device.

Referring to FIG. 2, which shows a flat view of the device. The device further comprises an upper strap 120 and a lower strap 130. The upper strap extends along the upper periphery and further from the right side of the mesh portion. Similarly, the lower strap extends along the lower periphery and further from the right side of the mesh portion. The upper strap and the lower strap run parallel to each other. Opposite to the upper strap and the lower strap can be provided D rings i.e., on the left side of the mesh. The upper D rings 140 can be used to fasten the respective upper straps and the lower D-rings 150 can be used for fastening the lower straps.

For installing the device 100 on a pipe 10, the device can be wrapped around the pipe having the lower edge thereof touching the floor 20 and covering the penetration (not shown). Once wrapped, the same can be secured by fastening the straps. The upper strap can be passed through the upper D ring for fastening the same. The lower strap can be fastened to the lower D rings.

Each of the upper and lower straps can also be provided with additional fasteners, such as hook and loop fasteners 160. FIG. 2 shows the hook and loop fastener 160 on the two straps and the mesh portion. The free ends of the two straps can be further secured to the mesh, using the hook and loop fastener.

In a preferred embodiment, the disclosed device can prevent debris and small articles from falling into oil rig deck penetrations.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for covering a floor penetration around a pipe, the method comprising:
providing a device comprising:
a mesh portion having an upper edge portion, a lower edge portion, a right edge, and a left edge;
an upper strap coupled to a portion of the upper edge portion and further extends away from the right edge; and
a lower strap coupled to a portion of the lower edge portion and further extends away from the right edge;
wrapping the mesh portion around the pipe such that the lower edge of the mesh portion is in contact with the floor and covering the floor penetration; and
upon wrapping, fasten the upper strap and the lower strap to secure the device around the pipe.

2. The method of claim 1, wherein the device further comprises upper D rings and lower D rings, the upper D rings are for fastening the upper strap, and the lower D rings are for fastening the lower straps.

3. The method of claim 2, wherein the device further comprises hook and loop fasteners for securing the free ends of the upper strap and the lower strap.

4. A device for covering a floor penetration around a pipe, the device comprising:
a mesh portion having an upper edge portion, a lower edge portion, a right edge, and a left edge;
an upper strap coupled to a portion of the upper edge portion and further extends away from the right edge; and
a lower strap coupled to a portion of the lower edge portion and further extends away from the right edge.

5. The device of claim 4, wherein the device further comprises upper D rings and lower D rings, the upper D rings are for fastening the upper strap, and the lower D rings are for fastening the lower straps.

6. The device of claim 5, wherein the device further comprises hook and loop fasteners for securing the free ends of the upper strap and the lower strap.
